(19) United States
(12) Patent Application Publication
(10) Pub. No.: US 2013/0046843 A1
(43) Pub. Date: Feb. 21, 2013

(54) INFORMATION PROCESSING SYSTEM, MANAGING APPARATUS, AND COMPUTER-READABLE STORAGE MEDIUM

(71) Applicant: Haruki SAGARA, Tokyo (JP)

(72) Inventor: Haruki SAGARA, Tokyo (JP)

(21) Appl. No.: 13/585,317

(22) Filed: Aug. 14, 2012

(30) Foreign Application Priority Data
Aug. 16, 2011 (JP) 2011-177918
Jul. 5, 2012 (JP) 2012-151635

(51) Int. Cl. G06F 15/16

(52) U.S. Cl. 709/208

(57) ABSTRACT

An information processing system includes a plurality of managed devices; and a device managing apparatus configured to serve as a master and manage the managed devices. The device managing apparatus includes a receiving unit configured to receive a request for batch configuration to be performed on the managed devices from an external apparatus; and a control unit configured to delegate a batch configuration process to be performed on the managed devices to a managed device serving as a slave when the receiving unit receives the request for batch configuration.

### CROSS-REFERENCE TO RELATED APPLICATIONS

The present application claims priority to and incorporates by reference the entire contents of Japanese Patent Application No. 2011-177918 filed in Japan on Aug. 16, 2011 and Japanese Patent Application No. 2012-151635 filed in Japan on Jul. 5, 2012.

### BACKGROUND OF THE INVENTION

1. Field of the Invention

The present invention relates to an information processing system, a managing apparatus, and a computer-readable storage medium.

2. Description of the Related Art

Conventionally, an information processing system is known, in which a device managing apparatus performs batch configuration in accordance with predetermined setting contents (for example, a setting value group containing a plurality of setting items and values) on a plurality of managed devices (for example, network devices, such as printers, multifunction peripherals (MFPs), projectors, or server computers) connected to the device managing apparatus via a network.

The information processing system of this type allows a user to remotely configure a plurality of managed devices over the network without requiring the user to show up at the site of the managed devices.

However, in the information processing system described above, configuration processes between the device managing apparatus and the managed devices are performed synchronously; therefore, the device managing apparatus has to wait without starting a next process until the setting processes on the managed devices are completed. Therefore, the whole processing time of batch configuration increases in proportion to the number of the managed devices or the number of setting items.

Furthermore, to configure a plurality of devices more easily, there is a conventional technology (see Japanese Patent Application Laid-open No. 2000-206835), in which a device serving as a master transmits user codes that are input via an operation panel to devices serving as slaves so that the user codes of the devices serving as the slaves can be set in bulk.

However, even in the technology disclosed in Japanese Patent Application Laid-open No. 2000-206835, configuration processes between the device serving as a master (a master device) and the devices serving as slaves (slave devices) are performed synchronously; therefore, the master device has to wait without starting a next process until the configuration processes on the slave devices are completed. Therefore, the whole processing time of batch configuration increases in proportion to the number of slave devices or the number of setting items.

Therefore, there is a need to provide an information processing system, a managing apparatus, and a computer-readable storage medium capable of reducing the whole processing time of batch configuration.

### SUMMARY OF THE INVENTION

It is an object of the present invention to at least partially solve the problems in the conventional technology.

According to an embodiment, there is provided an information processing system that includes a plurality of managed devices; and a device managing apparatus configured to serve as a master and manage the managed devices. The device managing apparatus includes a receiving unit configured to receive a request for batch configuration to be performed on the managed devices from an external apparatus; and a control unit configured to delegate a batch configuration process to be performed on the managed devices to a managed device serving as a slave when the receiving unit receives the request for batch configuration.

According to another embodiment, there is provided a managing apparatus for managing a plurality of managed devices. The managing apparatus includes a receiving unit configured to receive a request for batch configuration to be performed on the managed devices from an external apparatus; and a control unit configured to delegate a batch configuration process to be performed on the managed devices to a managed device serving as a slave when the receiving unit receives the request for batch configuration.

According to still another embodiment, there is provided a non-transitory computer-readable storage medium with an executable program stored thereon and performed in a processor of a managing apparatus for managing a plurality of managed devices. The program instructs the processor to perform receiving a request for batch configuration to be performed on the managed devices from an external apparatus; and delegating a batch configuration process to be performed on the managed devices to a managed device serving as a slave when the request is received at the receiving.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an overall configuration of an information processing system according to an embodiment;

FIG. 2 is a block diagram of a hardware configuration of a control system of each of a device managing apparatus and an administrator client terminal;

FIG. 3 is a block diagram of a hardware configuration of a managed device (a multifunction peripheral);

FIG. 4 is a block diagram of functional configurations of the device managing apparatus and the managed device;

FIGS. 5A to 5C are diagrams for explaining an example of device information;

FIG. 6 is a sequence diagram illustrating the flow of a process performed by the device managing apparatus when the device managing apparatus receives a request for batch configuration from the administrator client terminal;

FIG. 7 is a diagram illustrating an example of a batch configuration request screen;

FIG. 8 is a flowchart illustrating the flow of a process performed by a setting processing unit for determining a managed device (a sub system) to which a batch configuration process is delegated; and

FIG. 9 is a sequence diagram illustrating the flow of a process performed by a sub system when the sub system receives a delegation request for delegation of the batch configuration process from the device managing apparatus.

### DETAILED DESCRIPTION OF THE PREFERRED EMBODIMENTS

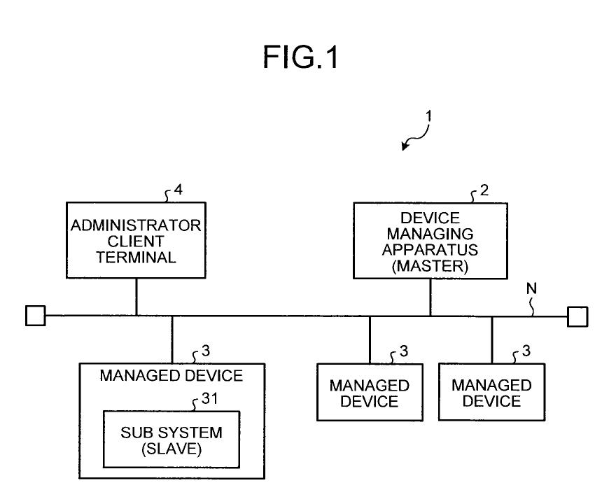

Exemplary embodiments of the present invention will be explained in detail below with reference to the accompanying drawings. First, a configuration of an information processing system 1 according to an embodiment will be explained below with reference to FIG. 1. FIG. 1 is a block diagram of an overall configuration of the information processing system 1 according to the embodiment.

As illustrated in FIG. 1, the information processing system 1 includes a device managing apparatus (master) 2, a plurality of managed devices 3 (three managed devices in the example in FIG. 1), and an administrator client terminal 4, which are communicably connected to one another via a local area network (LAN).

In the information processing system 1, a sub system (slave) 31 can be deployed and undeployed in any of the managed device 3 to perform batch configuration on the managed devices 3 (to perform configuration on all the managed devices 3 specified by a system administrator in accordance with predetermined setting contents (a setting value group containing a plurality of setting items and values)), based on a delegation request for delegation of a batch configuration process issued by the device managing apparatus (master) 2. The sub system 31 is formed by, for example, software or components. Here, “deployment” means that the sub system 31 is enabled and “undeployment” means that the sub system 31 is disabled.

The device managing apparatus (master) 2 is a device that manages the managed devices 3 via a network N, and is realized by, for example, a server device. The device managing apparatus 2 delegates the batch configuration process mentioned above to the sub system (slave) 31 deployed in the managed device 3.

The managed devices 3 are devices managed by the device managing apparatus 2, and are realized by, for example, multifunction peripherals (MFPs). The managed device 3 in which the sub system (slave) 31 is deployed receives a delegation request for delegation of the batch configuration process from the device managing apparatus (master) 2, and issues a request for configuration with the above setting contents to the managed devices 3.

The administrator client terminal 4 is a client terminal used by a system administrator of the information processing system 1, and is realized by a personal computer (PC) or the like. In the administrator client terminal 4, a user interface (UI) screen (a Web page etc.) provided by the device managing apparatus 2 via the network N is viewable. The administrator client terminal 4 is used by the system administrator for selecting the managed device 3 that performs batch configuration from among the managed devices 3 or for inputting a setting value.

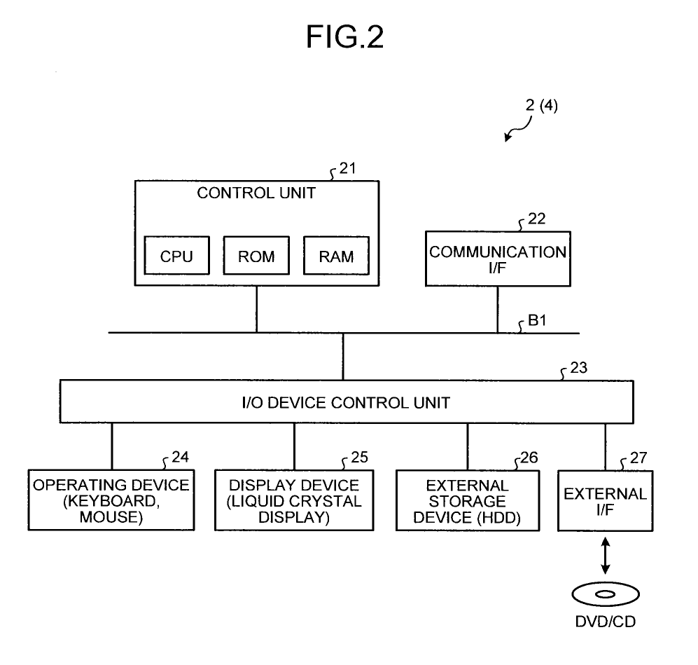

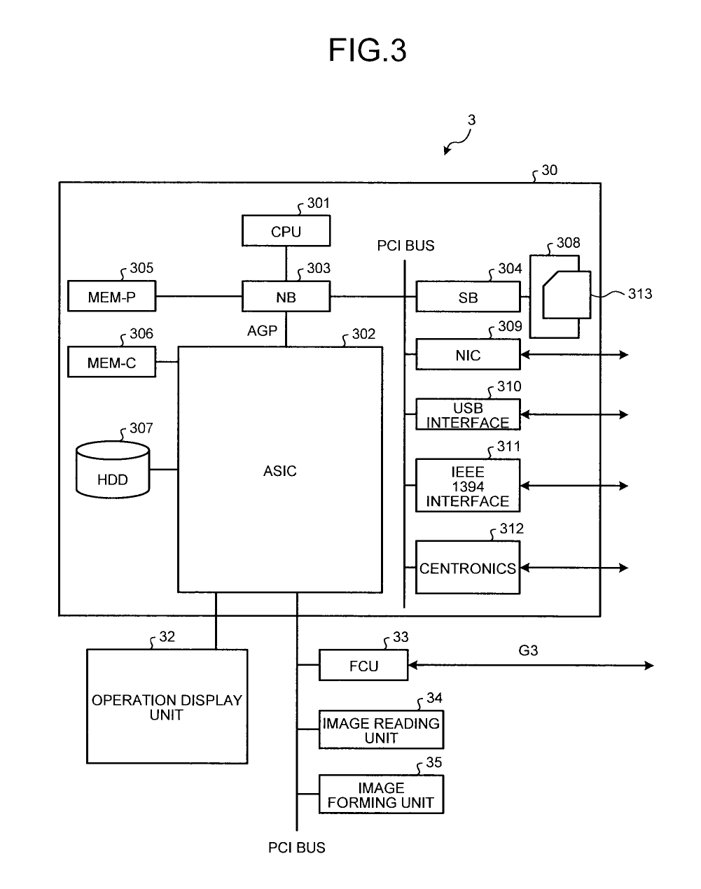

Hardware configurations of the device managing apparatus 2, the managed device 3, and the administrator client terminal 4 included in the information processing system 1 will be explained below with reference to FIG. 2 and FIG. 3.

FIG. 2 is a block diagram of the hardware configuration of a control system of each of the device managing apparatus 2 and the administrator client terminal 4.

As illustrated in FIG. 2, each of the device managing apparatus 2 and the administrator client terminal 4 has a hardware configuration using a general computer, such as a PC. Each of the device managing apparatus 2 and the administrator client terminal 4 includes, for example, a control unit 21, a communication interface (I/F) 22, and an input/output (I/O) device control unit 23, which are connected to one another via a bus B1.

The control unit 21 includes, for example, a central processing unit (CPU), a read only memory (ROM), a random access memory (RAM), or the like.

The control unit 21 is connected to an operating device (for example, a keyboard or a mouse) 24, a display device (for example, a liquid crystal display) 25, an external storage device (for example, a hard disk drive (HDD) or a solid state drive (SSD)) 26, and an external interface 27 (hereinafter, referred to as the “external I/F 27”) via the bus B1 and the I/O device control unit 23.

Specifically, the control unit 21 causes the CPU to load a control program stored in the ROM or the external storage device 26 onto the RAM and execute the control program to thereby control operations of the connected devices via the I/O device control unit 23. The control unit 21 also controls operations of transmitting and receiving various types of data to and from other connected devices via the communication I/F 22 and the network N.

The external I/F 27 is an interface for performing read and write operations on a recording medium, such as a digital versatile disk (DVD) or a compact disk (CD). It may be possible to store the control program in the recording medium, such as a DVD or a CD, and cause the CPU of the control unit 21 to read the control program from the recording medium, such as a DVD or a CD, via the I/O device control unit 23 and the external I/F 27, load the control program onto the RAM, and execute the control program.

FIG. 3 is a block diagram of the hardware configuration of the managed device (MFP) 3.

As illustrated in FIG. 3, the managed device 3 mainly includes a controller 30, an operation display unit (operation panel) 32, a facsimile control unit (FCU) 33, an image reading unit 34, and an image forming unit 35.

The controller 30 controls the entire managed device 3. Specifically, the controller 30 controls various processes, such as an image drawing process, a communication process, or an operation input and display process on the operation display unit 32.

In the example illustrated in FIG. 3, the controller 30 includes a CPU 301, an application specific integrated circuit (ASIC) 302, a north bridge (NB) 303, a south bridge (SB) 304, a system memory (MEM-P) 305, a local memory (MEM-C) 306, a hard disk drive (HDD) 307, a memory card slot 308, a network interface controller (NIC) 309, a universal serial bus (USB) interface 310, an institute of electrical and electronics engineers 1394 (IEEE 1394) interface 311, and a Centronics interface 312.

The CPU 301 is an integrated circuit (IC) for executing various types of information processing. The CPU 301 executes an application and a platform in parallel in units of processes by using an operating system (OS), such as a UNIX (registered trademark).

The ASIC 302 is an IC used for image processing. The NB 303 is a bridge for connecting the CPU 301 and the ASIC 302. The SB 304 is a bridge for connecting the NB 303 and peripheral devices. The ASIC 302 and the NB 303 are connected to each other via an accelerated graphics port (AGP).

The MEM-P 305 is a memory connected to the NB 303. The MEM-C 306 is a memory connected to the ASIC 302. The HDD 307 is a storage connected to the ASIC 302 and is used for storing image data, document data, programs, font data, form data, or the like. The memory card slot 308 is a slot connected to the SB 304 and is used for setting (inserting) a memory card 313.

The NIC 309 is a controller for performing data communication using a media access control (MAC) address via the network N. The USB interface 310 is an interface for providing a serial port compliant with the USB standard. The IEEE 1394 interface 311 is an interface for providing a serial port compliant with the IEEE 1394 standard. The Centronics interface 312 is an interface for providing a parallel port compliant with the Centronics specifications.

The NIC 309, the USB interface 310, the IEEE 1394 interface 311, and the Centronics interface 312 are connected to the NB 303 and the SB 304 via a peripheral component interconnect (PCI) bus.

The operation display unit 32 is a user interface for displaying an operating method for using various functions of the managed device 3 and for receiving input of operations from a user. The operation display unit 32 is connected to the ASIC 302.

The FCU 33 is a unit that controls a facsimile communication based on the facsimile group 3 (G3) standard or the like.

The image reading unit 34 is a unit that reads an image. For example, the image reading unit 34 is configured as a scanner and reads an image of a document set on a platen.

The image forming unit 35 is a unit that forms an image on a storage medium based on image data read by the image reading unit 34. For example, the image forming unit 35 employs an electrophotographic system.

The FCU 33, the image reading unit 34, and the image forming unit 35 are connected to the ASIC 302 via a PCI bus.

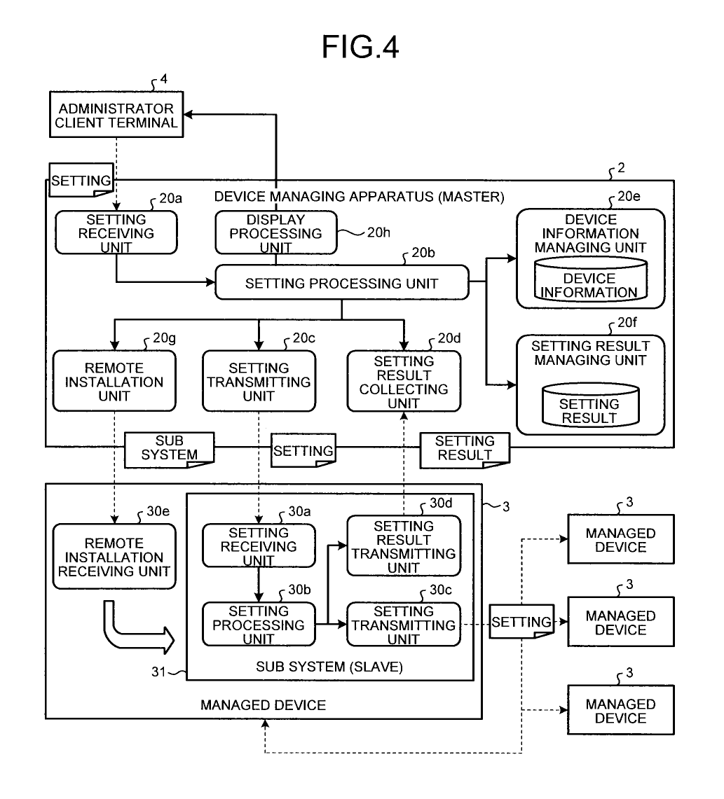

Functional configurations of the device managing apparatus 2 and the managed device 3 will be explained below with reference to FIG. 4.

FIG. 4 is a block diagram of the functional configurations of the device managing apparatus 2 and the managed device 3.

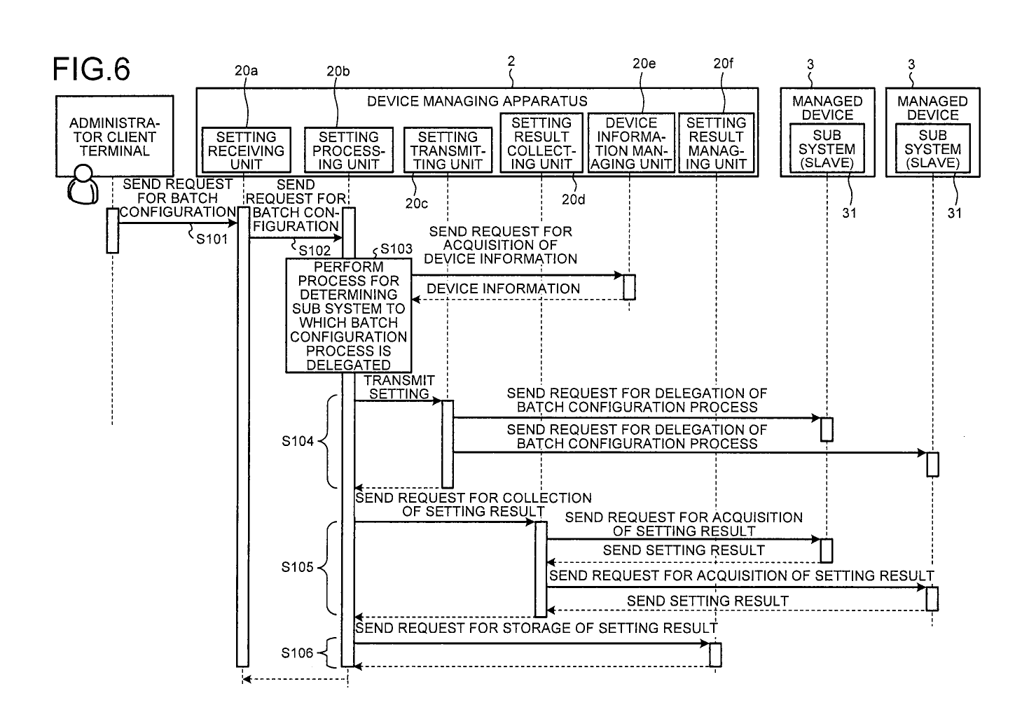

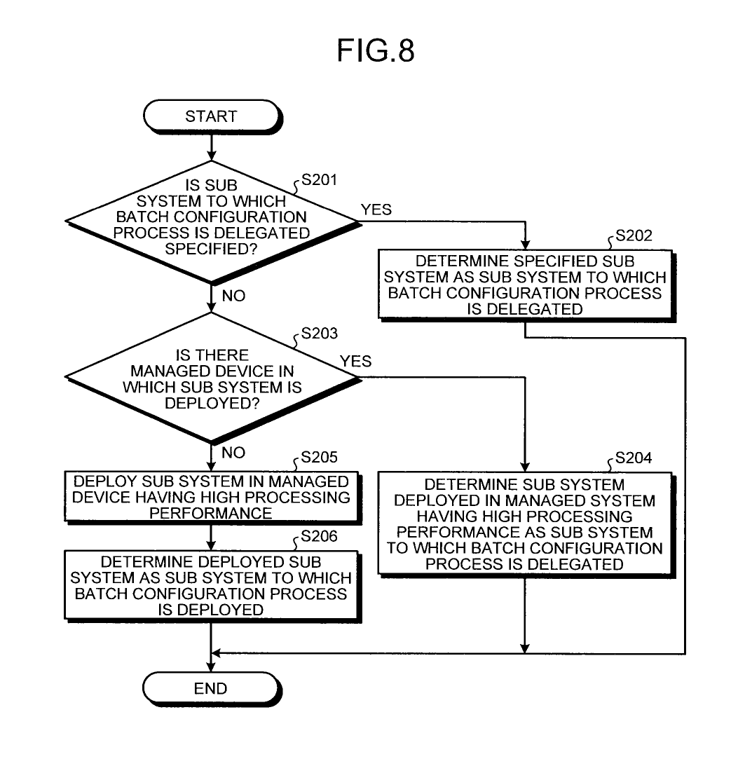

As illustrated in FIG. 4, the CPU of the device managing apparatus 2 loads a predetermined control program stored in the ROM or the external storage device 26 onto the RAM and executes the control program, thereby functioning as a setting receiving unit 20a, a setting processing unit 20b, a setting transmitting unit 20c, a setting result collecting unit 20d, a device information managing unit 20e, a setting result managing unit 20f, a remote installation unit 20g, and a display processing unit 20h for executing process sequences illustrated in FIG. 6 and FIG. 8 to be described later.

The display processing unit 20h performs a process for displaying various screens on the display device 25 of the device managing apparatus 2 and a process for transmitting a batch configuration request screen to the administrator client terminal 4 via the communication I/F 22 to display the batch configuration request screen on the display device 25 of the administrator client terminal 4. Details of the batch configuration request screen will be described later.

The setting receiving unit 20a receives a request for batch configuration specified on the batch configuration request screen from the administrator client terminal 4 via the communication I/F 22. The request for batch configuration contains a setting value group containing a plurality of setting items and values; identification information (device ID) of one or more of the managed devices 3 on which the configuration is to be performed; or the like.

The setting processing unit 20b executes various processes related to batch configuration. For example, the setting processing unit 20b performs a process for determining the managed device 3 to which a batch configuration process is delegated, and delegates the batch configuration process to the managed device 3 determined by the process.

Specifically, when the request for batch configuration received by the setting receiving unit 20a contains designation of the managed device 3 (the sub system 31) to which the batch configuration process is delegated, the setting processing unit 20b determines the designated managed device 3 (the sub system 31) as the managed device 3 to which the batch configuration process is delegated.

On the other hand, when the request for batch configuration received by the setting receiving unit 20a does not contain designation of the managed device 3 (the sub system 31) to which the batch configuration process is delegated, the setting processing unit 20b determines the managed device 3 in which the sub system 31 is deployed and which has high processing performance based on device information managed by the device information managing unit 20e to be described later, as the managed device 3 to which the batch configuration process is delegated.

The setting transmitting unit 20c transmits a delegation request for delegation of the batch configuration process to the managed device 3 (the sub system 31) determined by the setting processing unit 20b. The delegation request contains the setting value group described above, identification information on each of the managed devices 3 on which the batch configuration is to be performed by the sub system (slave) 31.

The setting result collecting unit 20d acquires a setting result of the batch configuration process from the sub system (slave) 31 deployed in the managed device 3 that performs the batch configuration process on behalf of the device managing apparatus 2 serving as a master. The setting result contains the identification information on the managed devices 3 on which the configuration has been performed, a setting result (success or failure) for each of the setting items, or a reason for failure when the configuration has failed.

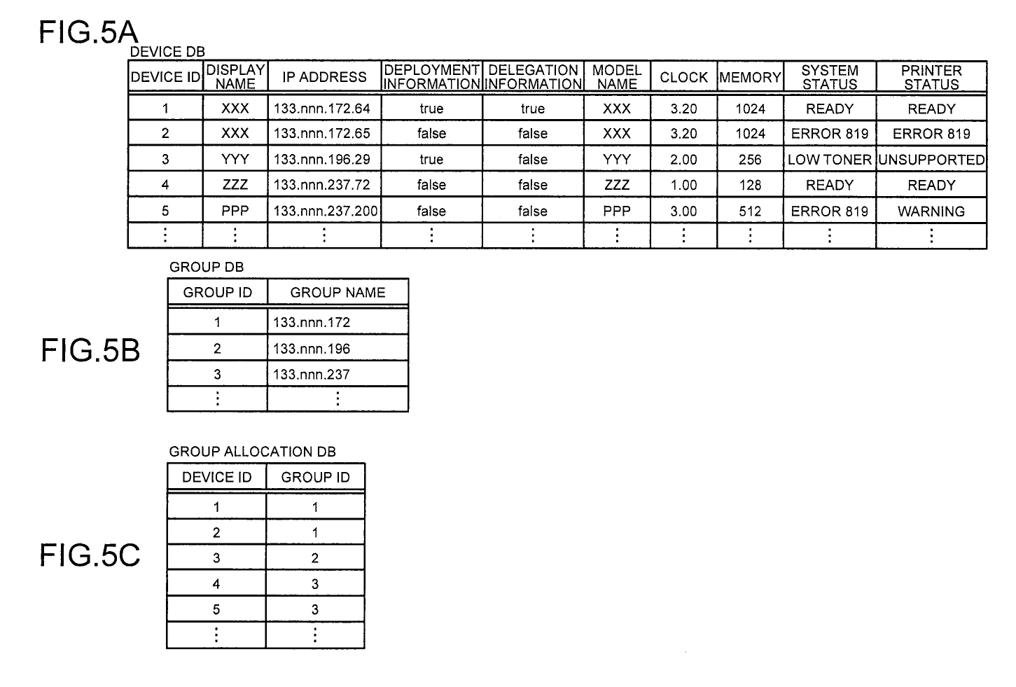

The device information managing unit 20e manages the device information on each of the managed devices 3 managed by the device managing apparatus 2. FIGS. 5A to 5C are diagrams for explaining an example of the device information. The device information contains a device database (hereinafter, described as the “device DB”) illustrated in FIG. 5A, a group database (hereinafter, described as the “group DB”) illustrated in FIG. 5B, and a group allocation database (hereinafter, described as the “group allocation DB”) illustrated in FIG. 5C.

The device DB is a database in which the device information on each of the managed devices 3 is registered. As illustrated in FIG. 5A, in the device information, a device ID for identifying the managed device 3, a display name of the managed device 3, an IP address needed for a communication, deployment information, delegation information, a model name, a clock rate of the CPU, a memory capacity of a mounted memory, system status, and printer status are registered in an associated manner.

The deployment information indicates a deployed state or an undeployed state of the sub system (slave) 31 in each of the managed devices 3. When the deployment information is “true”, it is indicated that the sub system 31 is deployed in the managed device 3. When the deployment information is “false”, it is indicated that the sub system 31 is undeployed in the managed device 3.

The delegation information indicates whether or not the batch configuration process is delegated to a sub system of the managed device. When the delegation information is “true”, it is indicated that the batch configuration process is delegated to the sub system. When the delegation information is “false”, it is indicated that the batch configuration process is not delegated to the sub system.

The model name, the clock rate of the CPU, and the memory capacity of the mounted memory are information indicating the specifications of the managed device 3 (that is, information by which the setting processing unit 20b determines the processing performance of the managed device 3). The system status indicates operating status of the managed device 3. For example, the system status indicates error status or the like. The printer status indicates status of a printer function of the managed device 3. For example, the printer status indicates error status, printing status, wait status, unsupported status, or the like.

As the device ID, an MAC address or a serial number may be used instead of the simple number illustrated in FIG. 5A. It may be possible to register authentication information in addition to the IP address in the device DB as the information needed for a communication.

The group DB is a database in which information on each of groups is registered. The group means a classification of the managed devices 3 based on the IP addresses. As illustrated in FIG. 5B, in the group DB, a group ID for identifying a group and a group name are registered in an associated manner. In the embodiment, the group name is represented by the first 24 bits of the IP addresses.

The group allocation DB is a database in which a group allocated to the managed device 3 is registered. As illustrated in FIG. 5C, in the group allocation DB, the device ID of each of the managed devices 3 and a group ID allocated to the device ID are registered in an associated manner.

Referring back to FIG. 4, the setting result managing unit 20f acquires the setting result collected by the setting result collecting unit 20d via the setting processing unit 20b and stores therein the setting result.

The remote installation unit 20g issues a request for deployment or undeployment of the sub system (slave) 31 to the managed device 3 under the control of the setting processing unit 20b.

As illustrated in FIG. 4, the CPU 301 of the managed device 3 loads a predetermined control program stored in the HDD 307 or the like onto a memory (the MEM-P 305 etc.) and executes the control program, thereby functioning as a setting receiving unit 30a, a setting processing unit 30b, a setting transmitting unit 30c, a setting result transmitting unit 30d, and a remote installation receiving unit 30e for executing the process sequence illustrated in FIG. 8 to be described later. Among the above functional units, the setting receiving unit 30a, the setting processing unit 30b, the setting transmitting unit 30c, and the setting result transmitting unit 30d are realized by the sub system (slave) 31.

The setting receiving unit 30a receives a delegation request for delegation of the batch configuration process from the device managing apparatus (master) 2.

When the setting receiving unit 30a receives the delegation request, the setting processing unit 30b performs various processes related to the batch configuration. Specifically, the setting processing unit 30b requests a plurality of the managed devices 3 designated in the delegation request to perform configuration with the above setting contents.

The setting transmitting unit 30c sends a request for configuration with the above setting contents to each of the managed devices 3 designated in the delegation request based on a transmission request from the setting processing unit 30b, receives a setting result (including the identification information on the managed device 3 that has performed the configuration, a setting result (success or failure) for each of the setting items, a reason for failure when the configuration has failed, or the like) from each of the managed devices 3 to which the request for configuration has been sent, and outputs the setting results to the setting result transmitting unit 30d described below.

The setting result transmitting unit 30d transmits the setting results received from the setting transmitting unit 30c to the device managing apparatus (master) 2 that has delegated the batch configuration process.

The remote installation receiving unit 30e receives a request for deployment or undeployment of the sub system (slave) 31 and deploys or undeploys the sub system (slave) 31 to which the request for deployment or undeployment has been sent.

Process operations performed by the information processing system 1 will be explained below with reference to FIG. 6 to FIG. 9.

FIG. 6 is a sequence diagram illustrating the flow of a process performed by the device managing apparatus (master) 2 when the device managing apparatus (master) 2 receives the request for batch configuration from the administrator client terminal 4.

The display processing unit 20h of the device managing apparatus (master) 2 displays the batch configuration request screen on the display device 25 of the administrator client terminal 4. As illustrated in FIG. 6, in the sequence, when a system administrator inputs a request for batch configuration through the batch configuration request screen displayed on the display device 25 by using the operating device 24 of the administrator client terminal 4 (Step S101), the setting receiving unit 20a receives the request for batch configuration and sends the request for batch configuration to the setting processing unit 20b (Step S102).

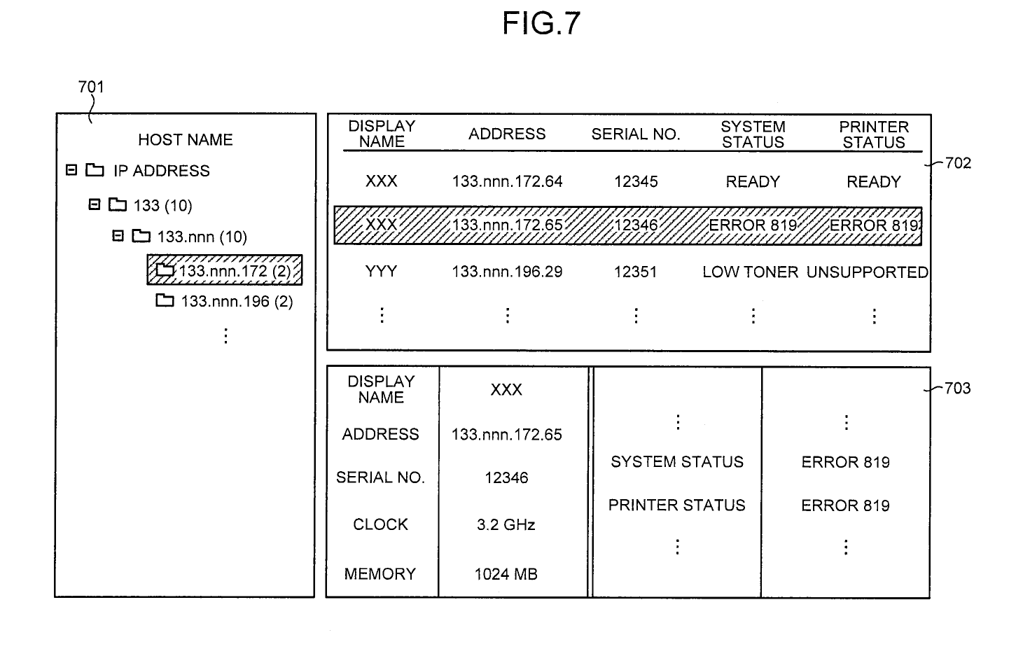

FIG. 7 is a diagram illustrating an example of the batch configuration request screen displayed on the display device 25. As illustrated in FIG. 7, the batch configuration request screen contains a group selection area 701, a device selection field 702, and a device information display area 703.

The system administrator can specify a desired group from among groups represented by the upper 24 bits of the IP addresses displayed in the group selection area 701. In the example in FIG. 7, a group with a group name of “133.nnn.172” is specified.

When the group is specified, the setting receiving unit 20a of the device managing apparatus (master) 2 receives the group ID of the specified group, and the setting processing unit 20b acquires device IDs associated with the specified group ID in the group allocation DB of the device information.

The display processing unit 20h of the device managing apparatus 2 transmits the display names associated with the acquired device IDs in the device DB of the device information to the administrator client terminal 4. Consequently, a list of the managed devices 3 belonging to the specified group is displayed in the device selection area 702 of the batch configuration request screen displayed on the display device 25 of the administrator client terminal 4.

The system administrator is allowed to select the managed device 3 that handles the request for batch configuration from the list of the managed devices 3 displayed in the device selection area 702. The system administrator is allowed not to select the managed device 3 that handles the request for batch configuration from the list of the managed devices 3. In the example illustrated in FIG. 7, the managed device 3 with the display name of “XXX” is selected in the list of the managed devices 3.

The device ID of the selected managed device 3 and the group ID of the specified group in the group DB are transmitted, as the information on the managed device 3 to which the batch configuration process is delegated, to the setting processing unit 20b of the device managing apparatus 2. When the managed device 3 that handles the request for batch configuration is not selected from the list of the managed devices 3, only the group ID is transmitted to the setting processing unit 20b of the device managing apparatus 2.

In the device information display area 703, contents of the device DB of the device information on the managed device 3 selected in the device selection area 702 are displayed. When the managed device 3 is not selected in the device selection area 702, nothing is displayed in the device information display area 703.

Referring back to FIG. 6, the setting processing unit 20b that has received the request performs a process for determining the managed device 3 (that is, the sub system (slave) 31) to which the batch configuration process is delegated (see FIG. 8) (Step S103).

FIG. 8 is a flowchart illustrating the flow of a process performed by the setting processing unit 20b for determining the managed device 3 (the sub system 31) to which the batch configuration process is delegated.

As illustrated in FIG. 8, the setting processing unit 20b determines whether the sub system 31 to which the batch configuration process is delegated is specified or not, based on the information (the device ID and the group ID) contained in the received request for batch configuration (Step S201). Specifically, the setting processing unit 20b determines whether the delegation information associated with the device ID specified in the request for batch configuration is “true” in the device DB of the device information.

At the above determination, when determining that the managed device (i.e., the sub system 31) to which the batch configuration process is delegated is specified (YES at Step S201), in other words, when the delegation information associated with the specified device ID is “true”, the setting processing unit 20b determines the managed device 3 (i.e., the sub system 31) corresponding to the specified device ID as the sub system 31 to which the batch configuration process is delegated (Step S202).

On the other hand, at the determination at Step S201, when determining that the managed device 3 (i.e., the sub system 31) to which the batch configuration process is delegated is not specified (NO at Step S201), in other words, when the delegation information associated with the specified device ID is “false” or when the request for batch configuration only contains the group ID and does not contain the device ID, the setting processing unit 20b determines whether the managed device 3 in which the sub system 31 is deployed is present in the group corresponding to the specified group ID, based on the device IDs of one or more of the managed devices 3 associated with the group ID contained in the received request for batch configuration and based on the device information (the device DB and the group DB) acquired from the device information managing unit 20e (Step S203).

Specifically, the setting processing unit 20b specifies the managed devices 3 with the device IDs allocated to the group ID contained (specified) in the request for batch configuration by referring to the group allocation DB of the device information. Subsequently, the setting processing unit 20b determines whether the deployment information associated with the device ID is “true” or not for each of the device IDs of the specified managed devices 3 by referring to the device DB of the device information.

At the determination at Step S203, when it is determined that the managed device 3 in which the sub system 31 is deployed is present in each of corresponding groups (YES at Step S203) (in other words, when there is a managed device with the device ID associated with the deployment information of “true”), and when it is also determined that one or more of (i.e., a plurality of) the sub systems 31 are present in each of the groups, the setting processing unit 20b determines the managed device 3 that has the highest processing performance in each of the groups based on the model name, the clock rate, or the memory capacity recorded in the device DB of the device information acquired from the device information managing unit 20e, searches for the sub system 31 deployed in the determined managed device 3, and determines the sub system 31 obtained as the search result, as the sub system 31 to which the batch configuration process is delegated (Step S204).

Specifically, the setting processing unit 20b determines that the managed device 3 corresponding to the device ID associated with the maximum clock rate or the maximum memory capacity in the device DB has the highest processing performance. Alternatively, the setting processing unit 20b determines that the managed device 3 corresponding to the device ID associated with the model name that is registered in advance as the name of a model having high processing performance in the device DB has the highest processing performance.

In the embodiment, the setting processing unit 20b determines the managed device 3 having the highest processing performance. However, it may be possible to configure the setting processing unit 20b so as to determine the managed device 3 having predetermined processing performance or greater. For example, it may be possible to configure the setting processing unit 20b so as to determine that the managed device 3 having the clock rate or the memory capacity greater than a predetermined clock rate or a predetermined memory capacity has the predetermined processing performance or greater.

On the other hand, at the determination at Step S203 described above, when it is determined that there is no managed device 3 in which the sub system 31 is deployed in each of the groups (NO at Step S203), in other words, when there is no managed device with the device ID associated with the deployment information of “true”, the setting processing unit 20b determines the managed device 3 having the highest processing performance for each of the groups in the above-described manner, based on the model name, the clock rate, or the memory capacity in the device DB of the device information acquired from the device information managing unit 20e, and deploys the sub system 31 in the determined managed device 3. Specifically, under the control of the setting processing unit 20b, the remote installation unit 20g sends a request for deployment of the sub system 31 to the corresponding managed device 3. Accordingly, the managed device 3 that has received the request deploys the sub system 31 (Step S205).

In the embodiment, the setting processing unit 20b determines the managed device 3 having the highest processing performance. However, it may be possible to configure the setting processing unit 20b so as to determine the managed device 3 having predetermined processing performance or greater. For example, it may be possible to configure the setting processing unit 20b so as to determine that the managed device 3 having the clock rate or the memory capacity greater than a predetermined clock rate or a predetermined memory capacity has the predetermined processing performance or greater.

To reduce a processing time of a deployment process for the sub system 31, it is preferable to maintain the sub system 31 in each of the managed devices 3 in an undeployed state; however, the present invention is not limited to this. It may be possible not to maintain the sub system 31 in each of the managed device 3. In this case, however, when the request for deployment of the sub system 31 is issued at Step S205 in FIG. 8, and if a target managed device 3 does not have the sub system 31, the remote installation unit 20g transmits the sub system 31 to the target managed device 3 under the control of the setting processing unit 20b.

In the processes at Step S204 and Step S205, the setting processing unit 20b excludes the managed device 3, to which delegation of the batch configuration process is prohibited in advance (the sub system 31 to be deployed in the managed device 3), from candidates to which the batch configuration process is to be delegated. Therefore, for example, the batch configuration process is not delegated to the managed device 3 in which it is not desirable to delegate the batch configuration process because the managed device 3 is used for other purposes.

Thereafter, the setting processing unit 20b determines the sub system 31 deployed by the process at Step S205 as the sub system 31 to which the batch configuration process is delegated (Step S206).

Referring back to FIG. 6, when the sub system 31 to which the batch configuration process is delegated is determined by the process at Step S103, the setting processing unit 20b delegates the batch configuration process to be performed on the managed devices 3 in the same group to one or more of the determined sub systems 31 via the setting transmitting unit 20c (Step S104).

Specifically, in the process at Step S104, the setting processing unit 20b transmits setting information, which contains the device ID for identifying the managed device 3 (the sub system 31) to which the batch configuration process is delegated, the device IDs of the managed devices 3 to be configured by the sub system 31, and setting contents (the setting value group containing a plurality of setting items and values, or the like), to the setting transmitting unit 20c. Accordingly, the setting transmitting unit 20c sends the delegation request for delegation of the batch configuration process to the corresponding managed device 3 (the sub system 31). The delegation request described above contains setting information with the same contents as those of the setting information described above.

In the embodiment, as illustrated in FIG. 6, at Step S104 described above, the setting processing unit 20b sequentially delegates the batch configuration process to a plurality of the managed devices 3 without waiting for a process result. With this structure, it becomes possible to reduce a processing time of a process for delegating the batch configuration process compared with a system in which the batch configuration process is delegated to a second managed device 3 after receiving a process result from a first managed device 3 to which the batch configuration process has been delegated. Furthermore, with the above structure, it becomes possible to reduce processing load on the device managing apparatus 2 serving as a master.

At Step S104 described above, after the request for the batch configuration process is sent to all the managed devices 3 (the sub systems 31), or in a thread different from the delegation request described above, the setting processing unit 20b acquires a result of the batch configuration process from each of the managed devices 3 (the sub systems 31) to which the batch configuration process is delegated (Step S105).

Specifically, in the process at Step S105, the setting processing unit 20b sends a request for collecting a result of the batch configuration process to the setting result collecting unit 20d. Accordingly, the setting result collecting unit 20d acquires a process result from each of the managed devices 3 (the sub systems 31) to which the batch configuration process is delegated, and sends the acquired process results to the setting processing unit 20b.

Thereafter, the setting processing unit 20b stores the process results acquired via the setting result collecting unit 20d in the setting result managing unit 20f (Step S106). Specifically, in the process at Step S106, the setting processing unit 20b sends the acquired process results to the setting result managing unit 20f. Subsequently, the setting result managing unit 20f stores the received process results in a storage unit, such as the external storage device 26.

Meanwhile, the sub system 31 is not needed except for when it is used for the batch configuration, and need not be always deployed. Therefore, when each of the managed devices 3 (the sub systems 31) to which the batch configuration process is delegated completes the batch configuration process, it is preferable to cause the setting processing unit 20b to undeploy the sub system 31 that has been deployed in each of the managed devices 3 to which the batch configuration process is delegated. Specifically, when the batch configuration process described above is completed, the remote installation unit 20g sends a request for undeployment of the sub system 31 to the corresponding managed device 3 and the managed device 3 that has received the request undeploys the sub system 31 under the control of the setting processing unit 20b. With this structure, it becomes possible to reduce load on the managed device 3 at a normal time (when the batch configuration process is not performed).

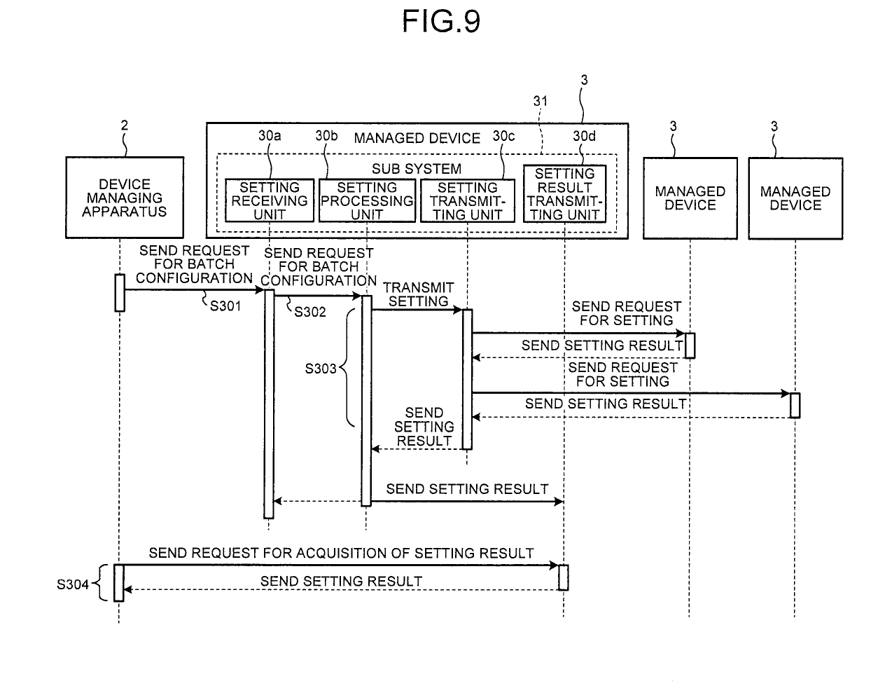

FIG. 9 is a sequence diagram illustrating the flow of a process performed by the sub system (slave) 31 when the sub system (slave) 31 receives the delegation request for delegation of the batch configuration process from the device managing apparatus (master) 2.

As illustrated in FIG. 9, in the sequence, the setting receiving unit 30a receives the delegation request for delegation of the batch configuration process from the device managing apparatus (master) 2 (Step S301), and sends a request for the batch configuration process to the setting processing unit 30b (Step S302).

The setting processing unit 30b receives the request and then sends a request for configuration with the above setting contents to each of the managed devices (configuration target devices) 3 designated in the delegation request via the setting transmitting unit 30c (Step S303).

Specifically, in the process at Step S303, the setting processing unit 30b sends, to the setting transmitting unit 30c, setting information containing identification information for identifying each of the managed devices 3 for which the configuration with the setting contents is requested and the setting contents (the setting value group containing a plurality of setting items and values) of the configuration performed on each of the managed devices 3. Subsequently, the setting transmitting unit 30c sends a request for the configuration with the setting contents to each of the corresponding managed devices 3. In the process at Step S303, when the managed device 3 (the sub system 31) that has received the delegation request for delegation of the batch configuration process is the configuration target device, the request for the configuration is sent to own device. The configuration target device may be the managed device 3 in which the sub system 31 is deployed.

At Step S303, the setting processing unit 30b acquires a setting result (the identification information of the target managed device 3, a setting result on the setting items (success or failure), or a reason for failure when the configuration has failed) from each of the managed devices 3, and sends the acquired setting result to the setting result transmitting unit 30d.

Thereafter, when receiving a request for acquisition of the setting result from the setting processing unit 20b of the device managing apparatus 2 serving as a master, the setting result transmitting unit 30d transmits the stored setting result to the device managing apparatus 2 (Step S304). As a result, the setting result collecting unit 20d of the device managing apparatus 2 acquires the setting result.

Specifically, in the embodiment, as illustrated in FIG. 8, at Step S303 described above, the setting processing unit 30b of the managed device 3 that has received the request for the batch configuration process sequentially sends a request for configuration with the setting contents to the managed devices 3 being the configuration target devices without waiting for process results (setting results) from the managed devices (configuration target devices) 3 for which the configuration with the setting contents has been requested. With this structure, it becomes possible to reduce a processing time for the batch configuration process compared with a system in which a request for configuration with the setting contents is sent to a second managed device 3 after a process result form a first managed device to which a request for the configuration with the setting contents has been sent.

In the embodiment described above, at Step S104 in FIG. 6, a case is explained in which the setting processing unit 20b of the device managing apparatus 2 delegates the batch configuration process to a plurality of the managed devices 3 (the sub systems 31); however, the present invention is not limited to this. For example, there may be a case in which a longer time is needed to transmit the delegation request depending on the setting contents. Therefore, it may be possible to specify only a trigger for instant acquisition or a time for acquisition in the sub system 31 at Step S104 to cause the sub system 31 to acquire the delegation request.

Furthermore, in the above embodiment, at Step S105 in FIG. 6, a case is explained in which the setting processing unit 20b of the device managing apparatus 2 requests each of the managed devices 3 (the sub systems 31) to which the batch configuration process is delegated to send a result of the batch configuration process; however, the present invention is not limited to this. For example, there may be a case that a process in the sub system 31 is not completed or the sub system 31 cannot return a response. Therefore, it may be possible to cause the sub system 31 to transmit the process result after the process in the sub system 31 is completed.

Moreover, in the above embodiment, at Steps S204 and S205 in FIG. 8, the managed device 3 having the highest processing performance is selected to deploy the sub system or the sub system deployed in the managed device 3 is determined as the sub system to which the batch configuration process is delegated. However, it may be possible to configure the setting processing unit 20b so as to exclude the managed device 3 whose system status indicates error or whose printer status indicates that printing is in operation, by referring to the system status or the printer status associated with the device ID of the managed device 3 selected as having the highest processing performance in the device DB of the device information. Alternatively, when the printer status indicates the wait state, the setting processing unit 20b may select this managed device 3 with priority.

Furthermore, in the embodiment, the managed devices 3 are grouped based on the IP addresses. However, it may be possible to classify the managed devices 3 based on segments instead of the groups and perform the same process as the process performed on the group. The segment means a predetermined section set by the system administrator etc. in advance. Examples of the segment include a section for classifying the managed devices 3 according to installed locations (for example, by a first floor and a second floor) or the section for classifying the managed devices according to the functions of the managed devices 3. The section is also referred to as a segment. In this case, it may be possible to register information for specifying the segment of each of the managed devices 3 in the device DB of the device information.

Furthermore, in the above embodiment, an example is explained in which the managed device 3 is the MFP. However, the present invention is not limited to this example. For example, the present invention may be applied to other network devices, such as printers, projectors, or server computers.

The program for executing the process sequences in the embodiment described above may be provided by being stored in advance in a storage device, such as a ROM, of each of the devices (the device managing apparatus 2, the managed device 3, and the administrator client terminal 4). The program described above may be provided by being stored in a computer-readable recording medium in a computer-installable or a computer-executable file format. The program described above may be provided or distributed via a network, such as the Internet.

According to one embodiment of the present invention, it is possible to reduce the whole processing time of batch configuration.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a plurality of managed devices; and
a device managing apparatus configured to serve as a master and manage the managed devices, the device managing apparatus including
a receiving unit configured to receive a request for batch configuration to be performed on the managed devices from an external apparatus; and
a control unit configured to delegate a batch configuration process to be performed on the managed devices to a managed device serving as a slave when the receiving unit receives the request for batch configuration.

2. The information processing system according to claim 1, wherein the control unit sequentially delegates the batch configuration process to the managed devices serving as slaves without waiting for a result of the batch configuration process from each of the managed devices serving as the slaves.

3. The information processing system according to claim 1, wherein the managed device serving as the slave sequentially sends the request for batch configuration to the managed devices to be configured without waiting for a result of a setting process from each of the managed devices to be configured.

4. The information processing system according to claim 1, wherein
the device managing apparatus further includes a managing unit configured to manage device information on each of the managed devices, wherein
when the receiving unit receives the request for batch configuration, the control unit determines whether there is a managed device in which a system for performing batch configuration is deployed among the managed devices based on the device information, and when determining that there are a plurality of managed devices in which the system is deployed, searches for a managed device having predetermined processing performance or greater from the determined managed devices based on the device information and delegates the batch configuration process to the managed device obtained as a result of search.

5. The information processing system according to claim 4, wherein the control unit searches for a managed device having predetermined processing performance or grater while excluding a managed device that is prohibited to perform batch configuration process.

6. The information processing system according to claim 1, wherein
the device managing apparatus further includes a managing unit configured to manage device information on each of the managed devices, wherein
when the receiving unit receives the request for batch configuration, the control unit determines whether there is a managed device in which a system for performing batch configuration on the managed devices based on the device information, and when determining that there is no managed device in which the system is deployed, searches for a managed device having predetermined processing performance or greater based on the device information, deploys the system to the managed device obtained as a result of search, and delegates the batch configuration process to the managed device in which the system is deployed.

7. The information processing system according to claim 6, wherein
the device managing apparatus further includes an undeployment unit configured to undeploy the system that has been deployed in the managed device when the managed device to which the batch configuration process is delegated completes the batch configuration process.

8. The information processing system according to claim 6, wherein the control unit searches for a managed device having predetermined processing performance or grater while excluding a managed device that is prohibited to perform batch configuration process.

9. The information processing system according to claim 1, wherein the device managing apparatus further includes an acquiring unit configured to acquire a setting result from the managed device to which the batch configuration process is delegated.

10. A managing apparatus for managing a plurality of managed devices, the managing apparatus comprising:
a receiving unit configured to receive a request for batch configuration to be performed on the managed devices from an external apparatus; and
a control unit configured to delegate a batch configuration process to be performed on the managed devices to a managed device serving as a slave when the receiving unit receives the request for batch configuration.

11. The managing apparatus according to claim 10, wherein the control unit sequentially delegates the batch configuration process to the managed devices serving as slaves without waiting for a result of the batch configuration process from each of the managed devices serving as the slave.

12. The managing apparatus according to claim 10, further comprising a managing unit configured to manage device information on each of the managed devices, wherein
when the receiving unit receives the request for batch configuration, the control unit determines whether there is a managed device in which a system for performing batch configuration is deployed among the managed devices based on the device information, and when determining that there is a plurality of managed devices in which the system is deployed, searches for a managed device having predetermined processing performance or greater based on the device information and delegates the batch configuration process to the managed device obtained as a result of search.

13. The managing apparatus according to claim 12, wherein the control unit searches for a managed device having predetermined processing performance or greater while excluding a managed device that is prohibited to perform the batch configuration process.

14. The managing apparatus according to claim 10, further comprising a managing unit configured to manage device information on each of the managed devices, wherein
when the receiving unit receives the request for batch configuration, the control unit determines whether there is a managed device in which a system for performing batch configuration is deployed among the managed devices based on the device information, and when determining that there is no managed device in which the system is deployed, searches for a managed device having predetermined processing performance or greater based on the device information, deploys the system in the managed device obtained as a result of search, and delegates the batch configuration process to the managed device in which the system is deployed.

15. The managing apparatus according to claim 14, further comprising an undeployment unit configured to undeploy the system that has been deployed in the managed device when the managed device to which the batch configuration process is delegated completes the batch configuration process.

16. The managing apparatus according to claim 14, wherein the control unit searches for a managed device having predetermined processing performance or greater while excluding a managed device that is prohibited to perform the batch configuration process.

17. The managing apparatus according to claim 10, further comprising an acquiring unit configured to acquire a setting result from the managed device to which the batch configuration process is delegated.

18. A non-transitory computer-readable storage medium with an executable program stored thereon and performed in a processor of a managing apparatus for managing a plurality of managed devices, wherein the program instructs the processor to perform:
receiving a request for batch configuration to be performed on the managed devices from an external apparatus; and
delegating a batch configuration process to be performed on the managed devices to a managed device serving as a slave when the request is received at the receiving.
